(19) United States
(12) Patent Application Publication
(10) Pub. No.: US 2022/0395755 A1
(43) Pub. Date: Dec. 15, 2022

(54) METHOD FOR BROADCASTING GAMEPLAY AND METHOD FOR JOINING GAME

(71) Applicant: Zeroplus Technology Co., Ltd., New Taipei City (TW)

(72) Inventor: CHIU-HAO CHENG, New Taipei City (TW)

(73) Assignee: Zeroplus Technology Co., Ltd., New Taipei City (TW)

(21) Appl. No.: 17/470,629

(22) Filed: Sep. 9, 2021

(30) Foreign Application Priority Data
Jun. 9, 2021 (TW) 110120945

(51) Int. Cl. A63F 13/86; A63F 13/70; H04N 21/2187; H04N 21/431; A63F 13/87

(52) U.S. Cl. CPC A63F 13/86; A63F 13/70; H04N 21/2187; H04N 21/4318; A63F 13/87; A63F 2300/303

(57) ABSTRACT

A method of broadcasting a game includes the following steps. During a game process, a server receives videos and audios that are obtained by a plurality of first computers and generates a first video file. The first video file is sent to a second computer. The second computer displays a first video file through a monitor, wherein a screen of the first video file does not include contents of concealed hand tiles of the player. A method for joining a game includes the following steps. The server receives a starting command from a starting computer to open a new game, wherein the starting command includes at least one bidding condition of the new game. The server receives a bidding command of a participating computer, and then determines that bidding price of the bidding command is complied with the bidding condition, the participating computer could be joined into the new game.

### BACKGROUND OF THE INVENTION

### Technical Field

The present invention relates generally to an online game, and more particularly to a method for broadcasting a game and a method for joining a game.

### Description of Related Art

A gambling game, such as mahjong and playing cards, is a popular entertainment. Mobile applications of the gambling game for computers, mobile devices, or other electronic devices are widespread. Take mahjong as an example, when a user plays mahjong through the electronic devices, the game is operated through a mouse or a touch screen. Thus, the user can not experience a feeling like playing the real mahjong, thereby reducing the fun of playing mahjong.

In the modern days, the users playing through the electronic devices can livestream a gameplay to the internet server, so that other users could watch the live gameplay through the internet. However, a convention method for livestreaming gameplay will allow contents of concealed hand tiles of the user to be displayed on a screen of the game (such as the gambling game). Once the gameplay is livestreamed through the internet, the fairness of the gambling game will be impaired, because concealed hand tiles of the user may be known by other players. Therefore, the gambling games played through the electronic devices are unable to be livestreamed by the conventional method.

When a host of a new game recruits for other participants to play together, the server opens for other users to join the new game freely. Alternatively, the server randomly selects or pairs the users to join the new game together. However, a conventional method of joining the new game is boring and uninspiring.

### BRIEF SUMMARY OF THE INVENTION

In view of the above, the primary objective of the present invention is to provide a method of broadcasting a gameplay which does not affect the fairness of games.

In addition, the another primary objective of the present invention is to provide a method for joining a game that allows the users to join via bid, thereby increasing fun.

The present invention further provides a game controller that makes the operation of the game more fun and convenient.

The present invention provides a method of broadcasting a gameplay that is applied to a game system, wherein the game system includes a plurality of computers and a server. The plurality of computers is connected to the server via the internet and includes a plurality of first computers and a second computer. Each of the plurality of computers is provided for one of a plurality of users to use. Each of the first computers is connected to a first monitor and a camera device, wherein the first monitor is adapted to display a game screen. When the user is playing the game, each of the plurality of first computers obtained a video and an audio of the user through the camera device. The second computer is connected to a second monitor. The method of broadcasting the gameplay includes the following steps:

A. During a game process:

A1. the server receives the video and the audio that is obtained by each of the first computers;

A2. the server generates at least one first video file based on the video and the audio obtained by at least one of the first computers, wherein the at least one first video file includes the videos and the audios obtained by the first computers, and a plurality of concealed hand tiles of at least one of the user;

A3. the server transmits the at least one first video file to the second computer;

A4. The second computer displays the at least one first video file through the second monitor, wherein a screen of the at least one first video file displayed through the second monitor does not show contents of the plurality of concealed hand tiles.

With such design, a screen displayed by the monitor does not show the contents of the tiles of the first users during the live broadcasting, thereby increasing the fairness of the game.

The present invention provides a method for joining a game that is applied to a game system, wherein the game system includes a plurality of computers and a server. The plurality of computers are connected to the server via the internet and includes a starting computer and at least one participating computer. The starting computer is provided for setting up a new game. The method for joining the game includes the following steps:

A. The server receives a starting command from the starting computer to open a new game, wherein the starting command includes at least one bidding condition of the new game.

B. The server waits to receive a bidding command from at least one participating computer, wherein the bidding command includes a bidding price. After the server receives the bidding command of the at least one participating computer, the following steps are conducted:

The server determines whether the bidding price is complied with the bidding condition or not. When the bidding price is complied with the bidding condition, the participating computer is joined into the new game.

With such design, the user could join the new game via bid, thereby increasing fun.

The present invention provides a game controller including a case, a touch module, a control module, a communication module, and a memory, wherein the touch module, the control module, the communication module, and the memory are located in the case. The control module is electronically connected to the touch module, the communication module, and the memory. The user operates the touch panel to generate an electronic signal to the control module. The control module wireless communicates with a computer via the communication module and is adapted to transmit an operating command to the computers. The case of the game controller could be designed in various shapes, such as the shape of tiles of mahjong, the shape of playing cards, or the shapes of other cards.

With such design, the user may have a playing experience that is similar to that of playing the real mahjong or cards.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a system block diagram of the gameplay live stream system of a first embodiment according to the present invention;

FIG. 2 is a schematic diagram of a kind of the computers of said gameplay live stream system, showing the connection between the computer and the peripheral devices;

FIG. 3 is a schematic diagram of another kind of the computers of said gameplay live stream system, showing the connection between the computer and the peripheral device thereof;

FIG. 4 is a front view of the game controller of the embodiment according to the present invention;

FIG. 5 is a side view of the game controller of the embodiment according to the present invention;

FIG. 6 is a block diagram of the game controller of the embodiment according to the present invention;

FIG. 7 is a schematic diagram of the game controller of the embodiment according to the present invention;

FIG. 8 is a flowchart of the method for joining a game of the embodiment according to the present invention;

FIG. 9 is a schematic diagram of the scene of creating a game of the embodiment according to the present invention;

FIG. 10 is a schematic diagram of the scene during a game of the embodiment according to the present invention;

FIG. 11 is a schematic diagram of the game controller of the embodiment according to the present invention, showing the sensing regions of the game controller;

FIG. 12 is a schematic diagram of the game controller of the embodiment according to the present invention, showing one of the operating gestures of the game controller;

FIG. 13 is a schematic diagram of the game controller of the embodiment according to the present invention, showing a finger touches the touch panel;

FIG. 14 is a schematic diagram of the game controller of the embodiment according to the present invention, showing the operation of the game controller;

FIG. 15 is a schematic diagram of the game controller of the embodiment according to the present invention, showing the operation of the game controller;

FIG. 16 is a block diagram of the game controller of another embodiment according to the present invention, showing the connections between the components of the game controller;

FIG. 17 is a schematic diagram of the game controller of the another embodiment according to the present invention, showing the configuration of the game controller;

FIG. 18 is a flowchart of the method of broadcasting the gameplay of the first embodiment according to the present invention during a game;

FIG. 19 is a schematic diagram of a scene of the first video file of the first embodiment according to the present invention;

FIG. 20 is a schematic diagram of a scene of the first video file of the first embodiment according to the present invention;

FIG. 21 is a schematic diagram of a scene of another first video file of the first embodiment according to the present invention;

FIG. 22 is a schematic diagram of a scene of the another first video file of the first embodiment according to the present invention;

FIG. 23 is a flowchart of the method of broadcasting the gameplay of the first embodiment according to the present invention after the game is over; and

FIG. 24 is a schematic diagram of a scene of the second video file of the first embodiment of the present invention.

### DETAILED DESCRIPTION OF THE INVENTION

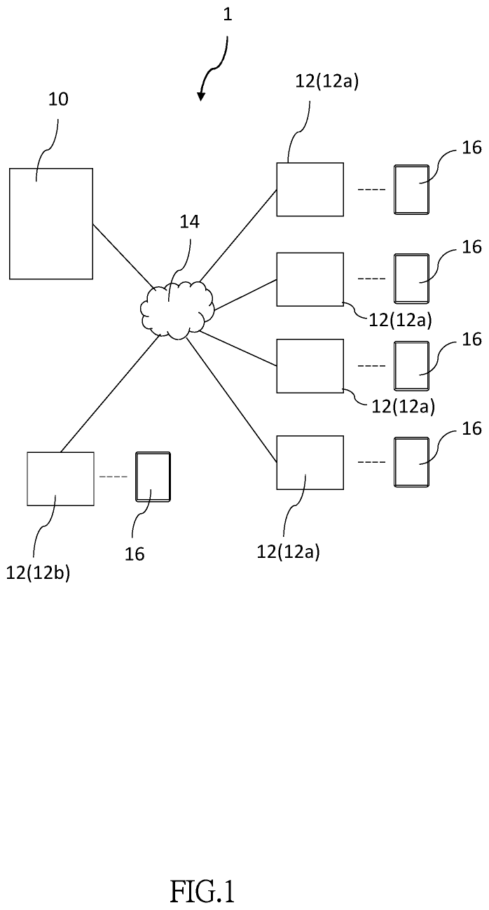

As illustrated in FIG. 1, a game system 1 of a first embodiment according to the present invention includes a server 10 and a plurality of computers 12, wherein the server 10 is connected to an internet 14 and is adapted to execute a game program for server end. In the current embodiment, the game program is a gambling game, such as a mahjong game. However, the game program includes but not limited to the mahjong game, poker games, and other card games. The plurality of computers 12 is located a plurality of user ends and is connected to the server 10 through the internet 14, wherein the computers 12 includes but not limited to a personal computer and a mobile device (such as a cellphone, a tablet computer, and a notebook). Each of the computers 12 could receive a positioning signal to obtain a positioning information, wherein the positioning signal includes but not limited to a GPS signal, an internet, and a telecommunication signal. Each of the computers 12 executes a game program for end-user and is connected to a game controller 16 that is specially designed for the game. A user could control the game by operating the game controller 16. Except using the game controller 16, the user could control the game via using a human interface device connected to each of the computers 12, such as a mouse, a keyboard, a touch screen, and so on. After each of the computers 12 is connected to the server 10, the users could play the game online together.

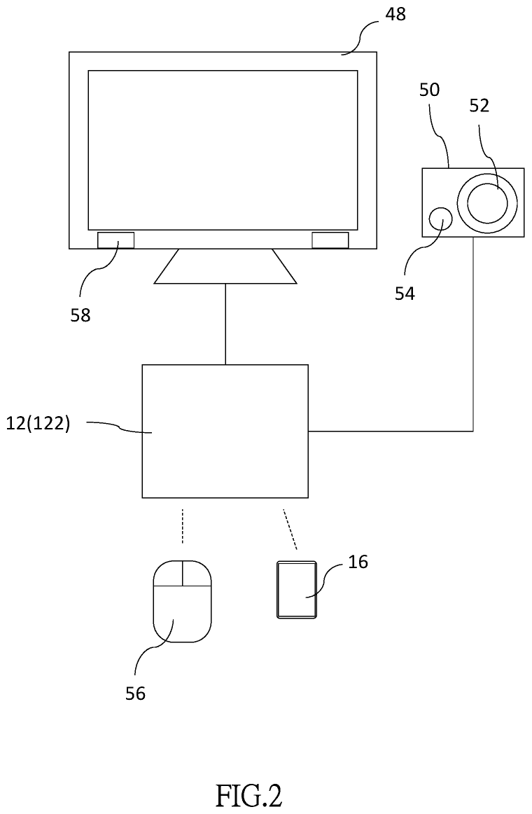

FIG. 2 illustrates one of the computers 12, wherein the computer 12 is a system unit 122 of the personal computer as an example. The computers 12 is connected to a monitor 48, a camera device 50, and a mouse 56. The monitor 48 is adapted to display a game screen. The camera device 50 could include a camera module 52 (such as a webcam) and a microphone module 54 (such as a microphone). When the computers 12 executes the game program for end-user, the camera module 52 and the microphone module 54 could respectively obtain a video and an audio of the user while the user is playing the game, and the video and the audio are uploaded to the server 10. The sound of the game could be played through a speaker 58. The user could operate the game via the mouse 56 or via the game controller 16. The game controller 16 is wireless connected to the computers 12 via Bluetooth, Zigbee and other wireless communication protocols, so that the computers 12 and the game controller 16 could mutually transmit commands.

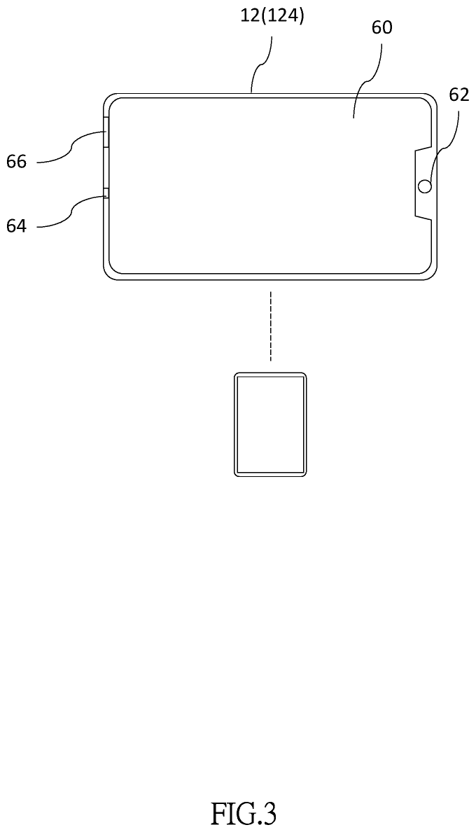

FIG. 3 illustrates one of the computers 12, wherein the computer 12 is a cellphone 124 as an example. The computers 12 has a monitor, which is a touch screen 60 as an example, a camera module 62, a microphone module 64, and a speaker 66. When the computers 12 executes the game program for end-user, the camera module 62 and the microphone module 64 could capture a video and an audio of the user, respectively, and the video and the audio are uploaded to the server 10. The user could play the game via the touch screen 60 or the game controller 16. The game controller 16 is wirelessly connected to the computers 12 via Bluetooth, Zigbee, and other wireless communication protocols.

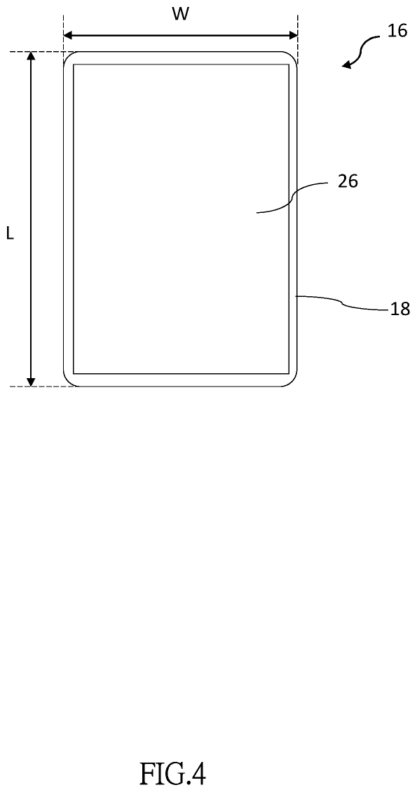

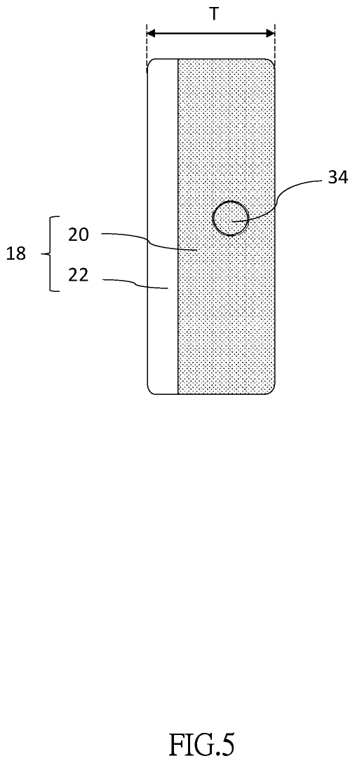

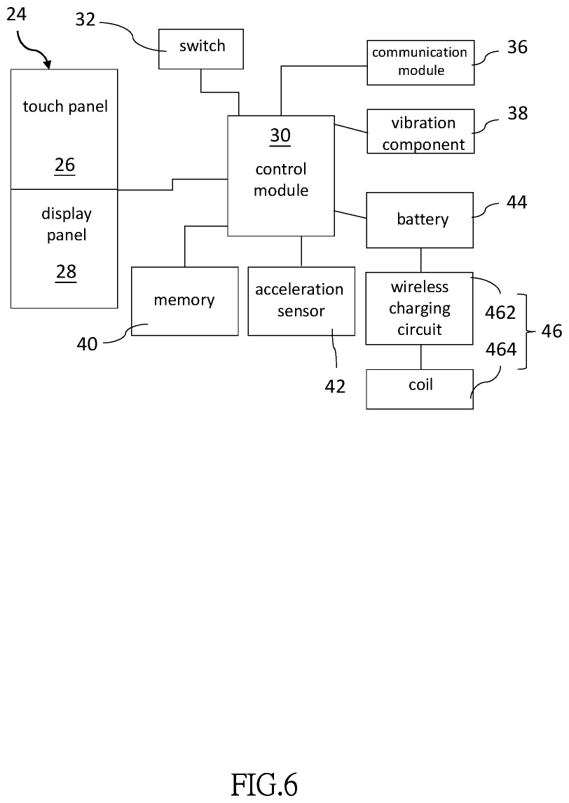

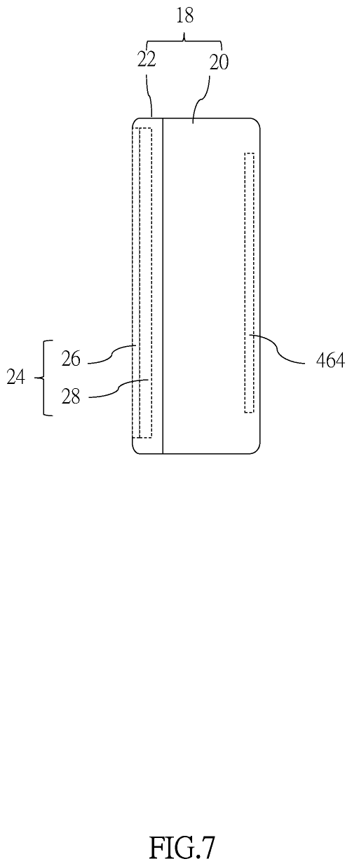

As illustrated in FIG. 4 to FIG. 7, the game controller 16 of the current embodiment adopts an appearance of a tile of mahjong. In other embodiment, a game controller that is specially designed for each of the different gambling games could adopt an appearance of a specific card shape, such as a shape of pokers or a shape of other cards. The game controller 16 includes a case 18, wherein the case 18 has a length L of 44 mm, a width W of 33 mm, and a thickness T of 20 mm. The case 18 is formed by coupling a first case body 20 and a second case body 22, wherein a thickness of the first case body 20 is greater than a thickness of the second case body 22. Additionally, a color of the second case body 22 is different than a color of the first case body 20. The game controller 16 includes a touch module 24, a control module 30, a switch 32, a communication module 36, a vibration component 38, a memory 40, a position sensor, a battery 44, and a wireless charging module 46, which are disposed in the case 18, wherein the position sensor is an acceleration sensor 42 as an example.

The touch module 24 is disposed in the second case body 22 and includes a touch panel 26 and a display panel 28. The touch panel 26 is located at an outmost side and is made of an optically transparent material. The touch panel 26 is adapted to be touched by the user. The display panel 28 is located at an inner side of the touch panel 26 and could be a liquid-crystal display panel (abbreviated as LCD panel) or a light-emitting diode (LED) dot-matrix display. The user could see an image displayed by the display panel 28 through the touch panel 26. Preferably, a separating plate is disposed between the touch panel 26 and the display panel 28, wherein the separating plate is optically semi-transparent and has a color, such as white or other light colors. Thus, when the display panel 28 does not display any image, the user sees the separating plate through the touch panel 26 as if a white or light color front side of a real tile of the mahjong.

The control module 30 is electronically connected to the touch module 24, the switch 32, the communication module 36, the vibration component 38, the memory 40, the acceleration sensor 42, and the battery 44. In the current embodiment, the control module 30 could be a microcontroller.

An electric signal generated by operating the touch panel 26 by the user is transmitted to the control module 30. The control module 30 could control the display panel 28 to show specific images. The switch 32 is adapted to control the control module 30 to turn on or off. The switch 32 is connected to a button 34 for pressing by a user. In the current embodiment, the button 34 is located at a lateral side of the first case body 20 of the case 18.

The control module 30 wirelessly communicates with the computer 12 via the communication module 36 to transmit a control command to the computer 12 or to receive a control command from the computer 12. In the current embodiment, the communication module 36 is, but not limited to, a bluetooth module. In other embodiments, the communication module 36 could also be a Zigbee module or other wireless communication modules.

The control module 30 could control the vibration component 38 to generate vibration. In the current embodiments, the vibration component 38 could be a vibration motor.

The memory 40 is provided for storing data. For example, the memory 40 could save image data, wherein the image data could include multiple images of tiles. The images of tiles include three suits of suited tiles (1-9 Dots, 1-9 Bamboo, 1-9 Characters), four season tiles (Spring, Summer, Fall, Winter), four flower tiles (Plum, Orchid, Bamboo, Chrysanthemum), and two sets of honors tiles including four winds (East, South, West, North) and three dragons (Red, Green, White). The image data of the tiles is not limited to the above. The image data of the tiles could be adjusted to be complied with the mahjong rule in the different regions. Additionally, the memory 40 could further store other image data. The control module 30 reads the image data stored in the memory 40 and displays the image corresponding to each of the image data through the display panel 28. The image data could be pre-stored in the memory 40. Alternatively, the image data could be obtained from the computers 12 via the communication module 36 to update the memory 40.

Additionally, the memory 40 could further store a specific identification code of the game controller 16 and a game point data. The specific identification code could be bound to an account. For example, after the game controller 16 is connected to the computer 12, the control module 30 reads the specific identification code in the memory 40 and transmits the specific identification code to the computer 12 via the communication module 36. In this way, the specific identification could be bound with at least one game account in the game program for end-user, and the game account and the specific identification code that is bound with the game account are uploaded to the server 10 to be recorded. After that, only the game account that is bound to the game controller 16 could be used no matter which computer 12 the game controller 16 is connected, so that the game controller 16 prevents from being arbitrarily taken by others to play the game through another game account which is unbound. In the current embodiment, a basic game point is recorded in the game point data of the memory 40 after the game controller 16 is manufactured. The game points could be updated through the communication module 36 during playing the game, such as spending points or depositing points.

The control module 30 could be integrated with an encryption integrated circuit (IC) to improve the safety of accessing the data in the memory 40.

In an embodiment, to bind a plurality of game accounts to one specific identification code, one of the plurality game accounts is taken to be a main account, and then record the rest of the plurality game accounts in the server 10 to enable the rest of the plurality game accounts to be bound to the specific identification code. The plurality of game accounts could use or deposit the game points in the memory 40 of the game controller 16.

The server 10 could record each of the game accounts of the users and the game points of each of the game accounts. The game points recorded in the server 10 and the game points in the memory 40 of the game controller 16 could be mutually transferred via the internet 14 of the computer 12.

The acceleration sensor 42 is an accelerometer that is adapted to sense a motion of the game controller 16. For example, when the user swings the game controller 16, the control module 30 could determine the motion of the game controller 16 is a swingy gesture of the user based on a sensing result of the acceleration sensor 42 and transmit a command corresponding to the swing to the computer 12 via the communication module 36. The computer 12 could control the game according to the swingy gesture of the user. Except for the swingy gesture, the user could slide on the touch module 24 with a finger, the control module 30 could determine a sliding gesture, which is performed by the user to the touch module 24, and send a command corresponding to the operating gesture to the computer 12 via the communication module 36.

The battery 44 supplies power to the control module 30. Additionally, the battery 44 supplies power needed by the touch module 24, the switch 32, the communication module 36, the vibration component 38, the memory 40, and the acceleration sensor 42. In the current embodiment, the battery 44 could be a storage battery.

The wireless charging module 46 could charge the battery 44 and includes a wireless charging circuit 462 and a coil, wherein the coil 464 is located at a rear side of the first case body 20. The coil 464 receives power provided by an external wireless charger, and the wireless charging circuit 462 transfers the power received by the coil 464 into an electronic power for charging the battery 44.

In an embodiment, the battery 44 could be an exchangeable battery, such as a button cell. With such design, the wireless charging module 46 is not necessary to be mounted.

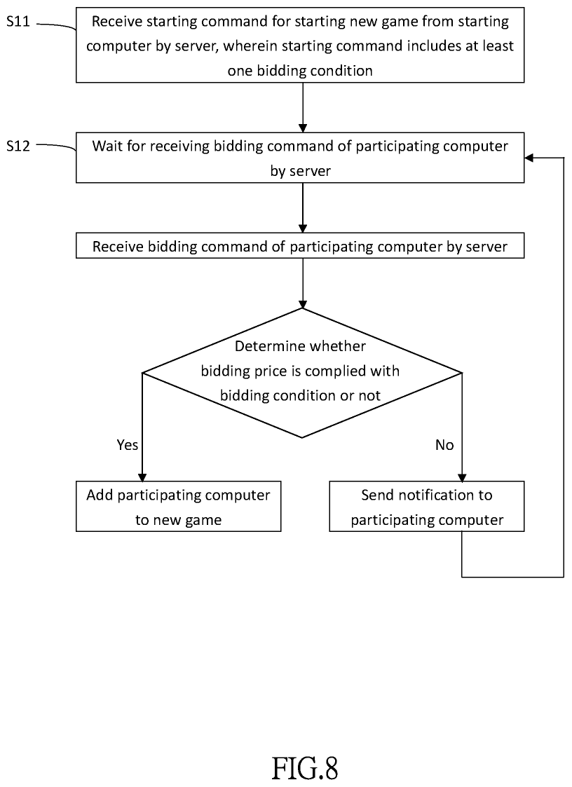

The following describes a method for joining a game of the current embodiment according to the present invention. For illustrated easily, the computers 12 are defined to include a starting computer and at least one participating computer. The starting computer is operated by the user to set up a new game. The at least one participating computer is a computer used by the user who joins said new game. As illustrated in FIG. 8, the method for joining the game includes the following steps:

Step S11: the server 10 receives a starting command for starting a new game from the starting computer, wherein the starting command includes at least one bidding condition.

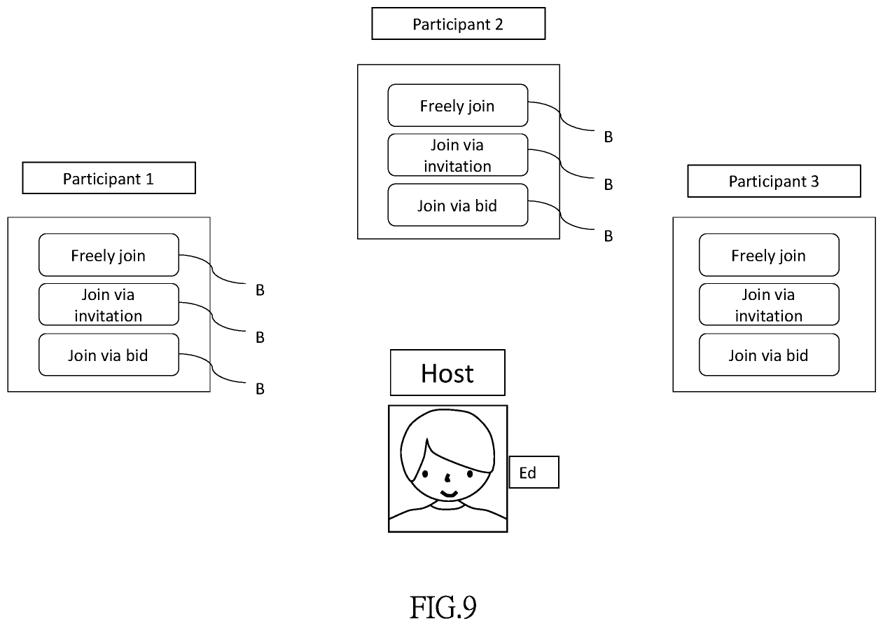

In the current embodiment, the user, who starts a new game, operates the starting computer to enter a setup screen displayed through the monitor. As illustrated in FIG. 9, in the setup screen, except the user (host) who starts a new game, there is a plurality of participants (participant 1 to participant 3). The host could set a joining condition for each of the participants, wherein options of the joining condition include a freely join, a join via invitation, and a join via bid.

As illustrated in FIG. 9, button images B represent the options of the joining condition that are provided for the host to select. When the host selects the option of freely join, the server 10 automatically joins the computers 12 that wait for playing a game to said new game. When the host selects the option of joining via invitation, the host could select the game accounts of other users and send an invitation. After users who are invited accept the invitation through the computers 12 of the invited users, the computers 12 of the invited users are joined to said new game. When the host selects the option of joining via bid, the bidding condition needs to be set, wherein the bidding condition could be “a bidding point should be greater than a minimum point and be the greatest among bidding points of other bids”, as an example. After that, the starting computer sends the starting command and the bidding condition corresponding to each of the participants to the server 10

Moreover, the starting computer sends a positioning information and a user information of the host (such as a game account, a nickname, and a brief introduction) to the server 10. After the server 10 receives the positioning information, the server connects the positioning information to said new game to set the positioning information of the new game and to save the user information of the host.

In an embodiment, the at least one participating computer could send a position searching command to the server 10, wherein the position searching command includes a searching region. The searching region could be a region within a radius of 500 meters around a specific location, as an example. However, the searching region is not limited to the above.

After the server 10 receives the position searching command from the participating computer and determines the positioning information of games that located within the searching region, the server 10 sends a game list including all the games that are located within the searching region to the participating computer. After a user of the at least one participating computer selects one of the games on the game list, the at least one participating computer sends a confirmation message to the server 10. After the server 10 receives the confirmation message, the at least one bidding condition of the selected game is sent to the at least one participating computer.

In other embodiments, the server 10 could provide an electronic map to the at least one participating computer. Games are marked on the electronic map according to the positioning information of each of the games. After a user of the at least one participating computer could select a game through the electronic map, a confirmation information is sent to the server 10. After the server 10 receives the confirmation information, the at least one bidding condition of the selected game is sent to the at least one participating computer.

The user of the at least one participating computers could see the bidding condition of the game through the monitor 48 to decide whether to bid or not. Additionally, the server 10 could send the user information of the starting computer that is stored in the server 10 to the at least one participating computer for referring by the user through the monitor 48. After the user of at least one of the participating computers decides to bid, the user could operate the participating computer to send a bidding command to the server 10, wherein the bidding command includes a bidding price which is a bidding point, as an example.

The starting computer obtains a live video and a live audio of the host through the camera device 50 of the starting computer and transmits to the server 10. After the server 10 receives the live video and the live audio, the live video and the live audio are sent to the participating computer, so that the user of the participating computer could watch the live video of the host of the new game through the monitor 48 and hear the live audio of the host through the speaker 58 of the participating computer, thereby increasing willingness of the user of the participating computer to bid.

Step S12: the server 10 waits for receiving a bidding command of the at least one participating computer. Before the step S02, the server 10 could set a bid participation time, so that the server 10 waits for a bidding command of the at least one participating computer within the bid participation time. After the server 10 receives the bidding command of the at least one participating computer, the following steps are carried out by the server 10:

Determine whether the bidding price is complied with the bidding condition or not.

If not, the server 10 sends a notification to the participating computer again to notify that the bidding price provided by the user of the participating computer does not meet the bidding condition and the bidding price is necessary to be adjusted, such as increasing the bidding point.

If yes, the participating computer enters the new game set by the starting computer, and the user of the participating computer becomes one of the participants of the new game.

Additionally, after the bid participation time is expired, the server 10 closes the bid and sends a notification to the starting computer and at least one of the participating computers.

In another embodiment, the starting command includes indicating that a plurality of participants of the new game and indicating at least one bidding condition for at least one of the plurality of participants. For example, the starting command includes indicating that the joining condition of one of the plurality participants as join via bid, and the joining condition of other participants could be indicated as freely join or join via invitation. In other embodiments, the starting command includes indicating that the joining condition of each of the plurality of participants is joining via bid, wherein the bidding condition for each of the plurality participants could be different. Namely, select the option of joining via bid for the plurality of participants, and set the bidding conditions for each of the plurality of participants.

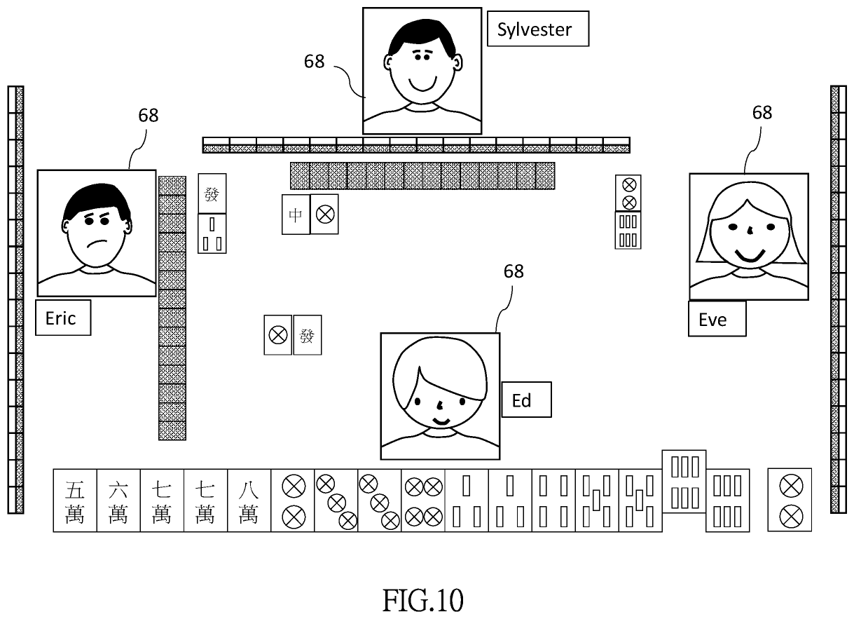

After each of the participants of the new game corresponds to one of the users, the new game is ready to start. Each of the users of the new game use one of the computers 12 to connect to the server 10 to play the game. Each of the computers 12 obtains a video and an audio and uploads to the server 10. FIG. 10 illustrates a game screen when four users are playing the game, wherein the game screen is displayed through the monitor 48 of one of the four users. The game screen includes a plurality of video regions 68, wherein the video regions 68 display the live videos of the users, and the speakers 58 connected to the computers 12 could play the live audio, so that the users could interact with each other. Each of the users of the computers 12 could choose not to display his/her video region 68 and only display the video regions 68 of the other three users.

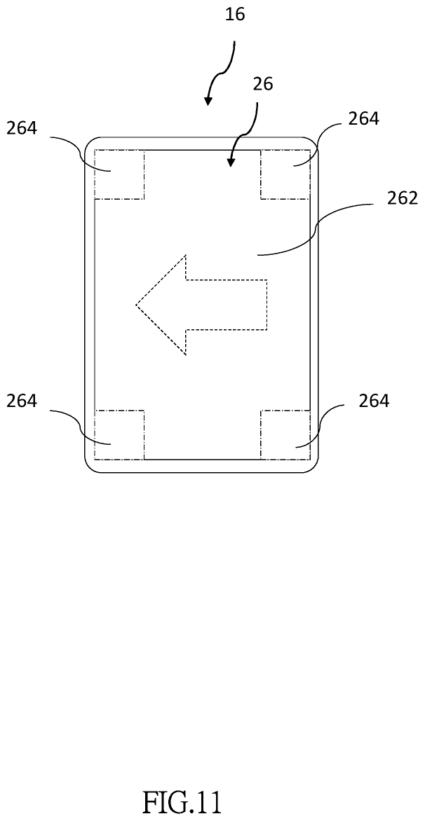

When the user presses the touch panel 26, according to an operating gesture of the user, the control module 30 could send an operating command, which corresponds to the operating gesture, to the computer 12 via the communication module 36. As illustrated in FIG. 11, when the user slides toward the left on the touch panel 26, the control module 30 sends an operating command corresponding to the gesture of sliding toward the left to the computer 12 via the communication module 36. After the computer 12 receives the operating command, the computer 12 selects a tile that is located at a left side of a currently selected tile. Similarly, when the user slides toward the right on the touch panel 26, the control module 30 sends an operating command corresponding to the gesture of sliding toward the right to the computer 12 via the communication module 36. After the computer 12 receives the operating command, the computer 12 selects a tile that is located at a right side of a currently selected tile. When the user slides upward on the touch panel 26, the control module 30 sends an operating command corresponding to the gesture of sliding upward to the computer 12 via the communication module 36. After the computer 12 receives the operating command, the computer 12 discards a tile that is selected currently during the game.

As illustrated in FIG. 11, the touch panel 26 could include a first touch sensing region 262 and a plurality of second touch sensing regions 264. The first touch sensing region 262 is a primary sensing region, and an area of the first touch sensing region 262 is greater than that of all of the second touch sensing regions 264. The second touch sensing regions 264 are located at a periphery of the first touch sensing region 262. In the current embodiment, the second touch sensing regions 264 are respectively located at four corners of the touch panel 26. The user could slide upward, downward, leftward, and rightward on the first touch sensing region 262 or touch the second touch sensing regions 264 to trigger the control module 30 to send the operating command that corresponds to each of the operating gestures. When the user touches each of the second touch sensing regions 264, the control module 30 sends an operating command that corresponds to the touched second touch sensing regions 264. When the computer 12 executes the game program for end-user, the computer 12 performs different controls in the game, such as drawing a tile, making a meld (chi/pong/kong), calling the menu, previous page, next page, exit game, according to different operating commands that are received.

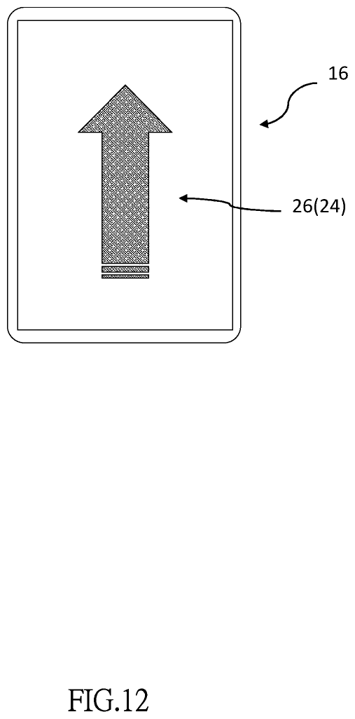

As illustrated in FIG. 12, when the computer 12 determines that it is the user's turn to draw a tile from the wall, the computer 12 transmits a drawing command to the game controller 16. After the communication module 36 of the game controller 16 receives the drawing command, the gesture of sliding upward corresponds to another operating command, namely an operating command of drawing a tile from the wall. Simultaneously, the control module 30 accesses an image corresponding to the drawing command from the memory 40 and displays the image through the display panel 28 to guide the user to perform the operating gesture of drawing a tile on the touch panel 26. For example, the image could be an image of an upward arrow as illustrated in FIG. 12, thereby giving a hint for the user to perform the gesture of sliding upward on the touch panel 26 to draw a tile from the wall.

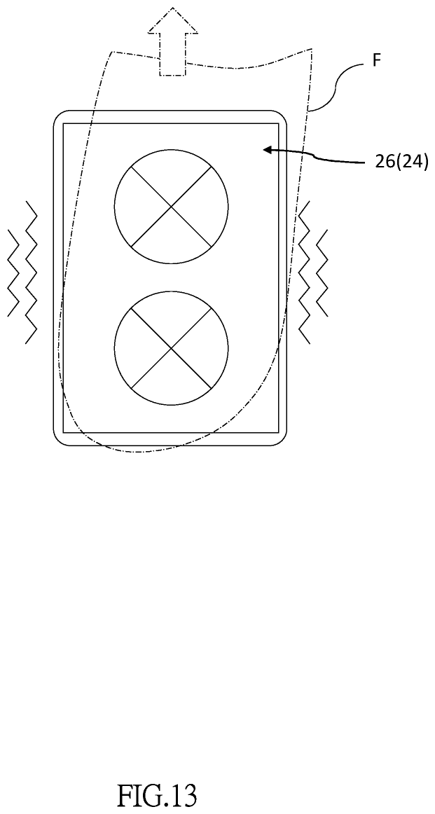

As illustrated in FIG. 13, when a finger F of the user slides upward on the touch panel 26, the control module 30 transmits an inquiry command to the computer 12 via the communication module 36. After the computer 12 receives the inquiry command, the computer 12 transmits a tile information of a tile that is drawn by the user back to the game controller 16. After the control module 30 receives the tile information via the communication module 36, the control module 30 finds an image data corresponding to the tile information and displays an image of tile of the image data corresponding to the tile information through the display panel 28, such as an image of two dots as shown in FIG. 13. Simultaneously, the control module 30 controls the vibration component 38 to vibrate, thereby generating a feedback to make the user have a lifelike experience of touching a real mahjong tile.

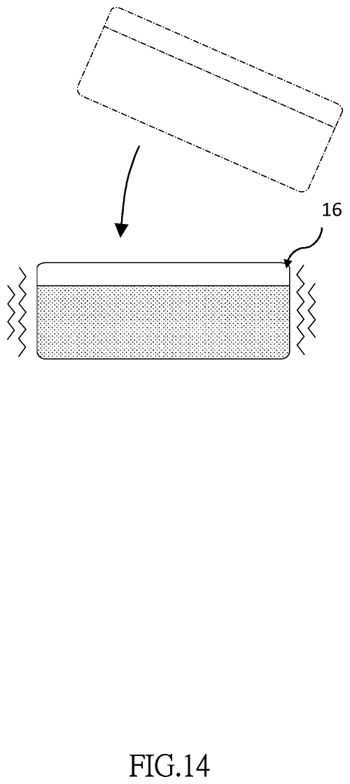

As illustrated in FIG. 14, when the user completes a legal winning hand, the user could swing the game controller 16 downward to a predetermined position. At this time, the acceleration sensor 42 senses the game controller 16 is swung downward, and the control module 30 sends a winning command to the computer 12 via the communication module 36, thereby declaring the winning hand in the game. Simultaneously, the control module 30 controls the vibration component 38 to vibrate to make the user feel like playing the real mahjong.

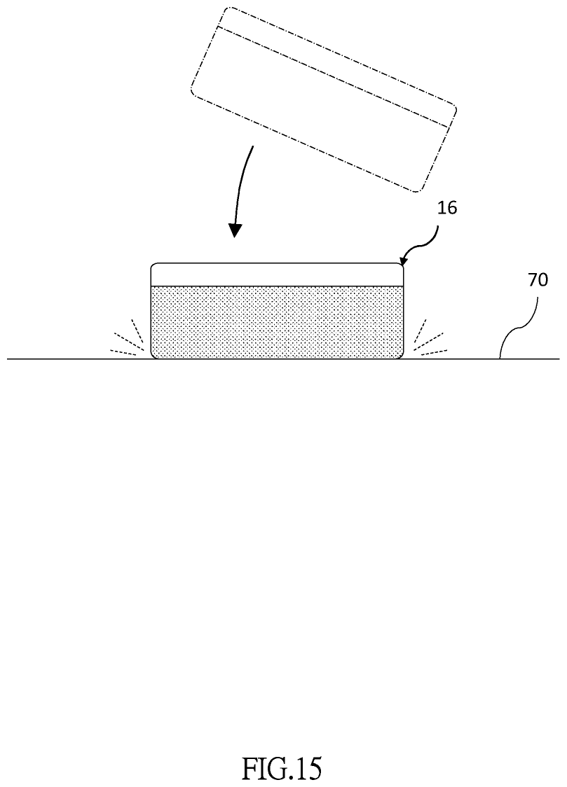

As illustrated in FIG. 15, alternatively, the user could swing the game controller 16 downward to a predetermined position and hit a top surface 70 of a desk, thereby enhancing the lifelike experience of win the mahjong. In an embodiment, the position sensor could be a vibration sensor to detect a degree of vibration when the game controller 16 hits the top surface 70 of the desk. The control module 30 determines the user wants to declare the winning hand when the degree of vibration attains a predetermined degree, so that the control module 30 sends a winning command to the computer 12.

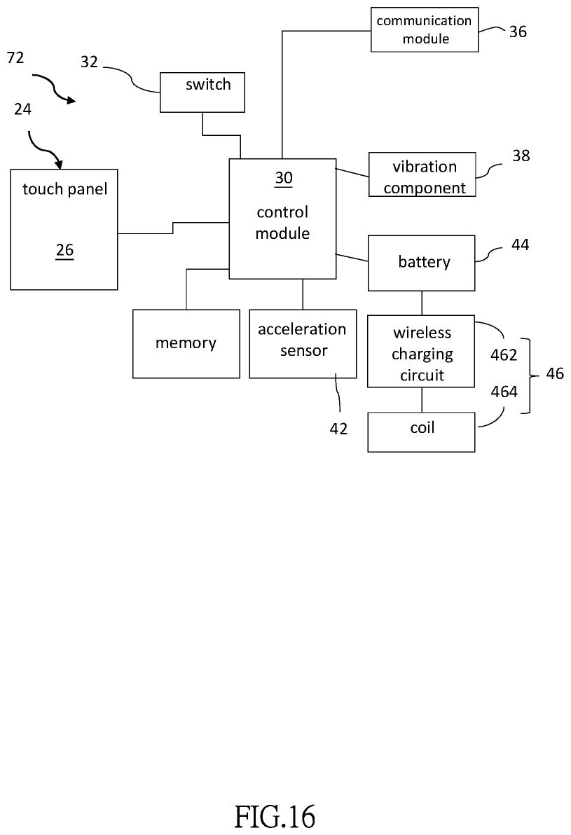

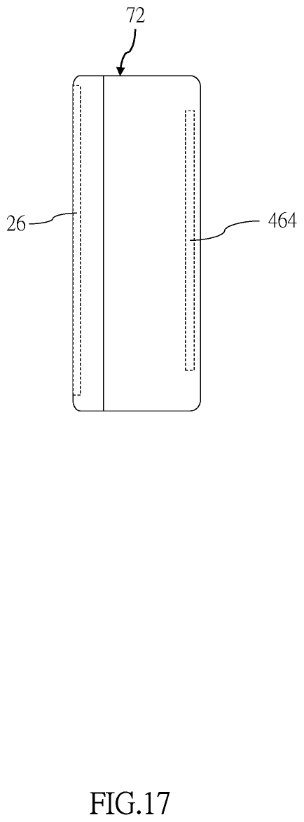

In another embodiment, a game controller 72 is illustrated in FIG. 16 and FIG. 17, wherein the touch module 24 includes the touch panel 26, and the display panel is omitted. Besides, the memory 40 of the game controller 72 does not store the image data.

In order to illustrate easily, the computers of the game system 1 are defined to include a plurality of first computers 12a and at least one second computer 12b. The users of the plurality of first computers 12a are defined as first users. A user of the at least one second computer 12b is defined as a second user. A monitor 48 connected to each of the first computers 12a is defined as a first monitor. A monitor 48 connected to the at least one second computer 12b is defined as a second monitor.

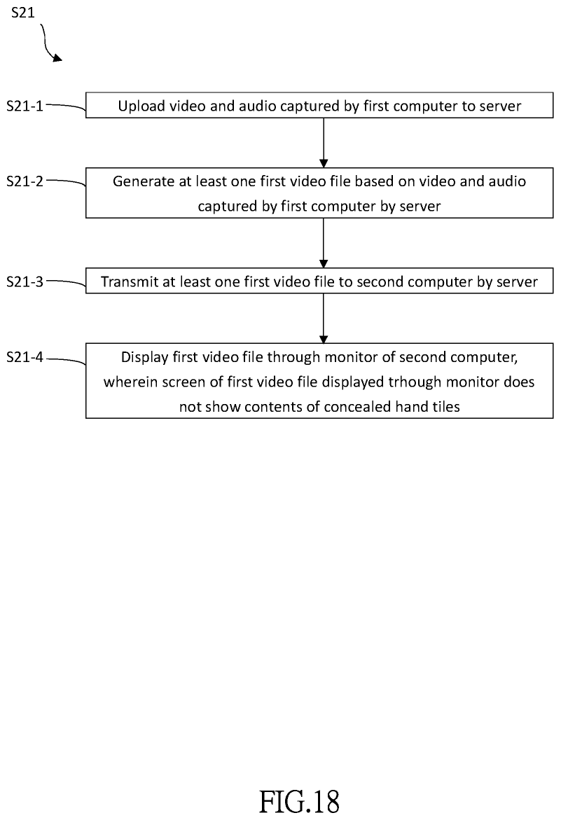

As illustrated in FIG. 18, the following describes a method of broadcasting gameplay.

The first users of the first computers 12a could set a game program executed on each of the first computer 12a to enter a livestreaming mode. Each of the first computers 12a could upload a live video and a live audio of the first user to the server 10 for live streaming a gameplay. The at least one second computer 12b allows the second user to play the game and to watch the gameplays of the first users.

Step S21: a game process includes the following steps:

Step S21-1: each of the first computers 12a uploads the video and the audio that are captured by the first computer 12a to the first computers 12a. The video and the audio could be sent to the server 10 in a form of a live video file as an example. The server 10 receives the videos and the audios that are captured by the first computers 12a. Each of the first computers 12a transmits a plurality of log data of the game to the server 10. The log data of each of the first computers 12a includes contents of a plurality of concealed hand tiles, a time of holding each of the concealed hand tiles, contents of a plurality of public tiles, and a time of opening each of the public tiles. The server 10 receives the log data sent from each of the first computers 12a.

Step S21-2: the server 10 generates at least one first video file based on the video and the audio captured by the first computers 12a and stores the at least one first video file.

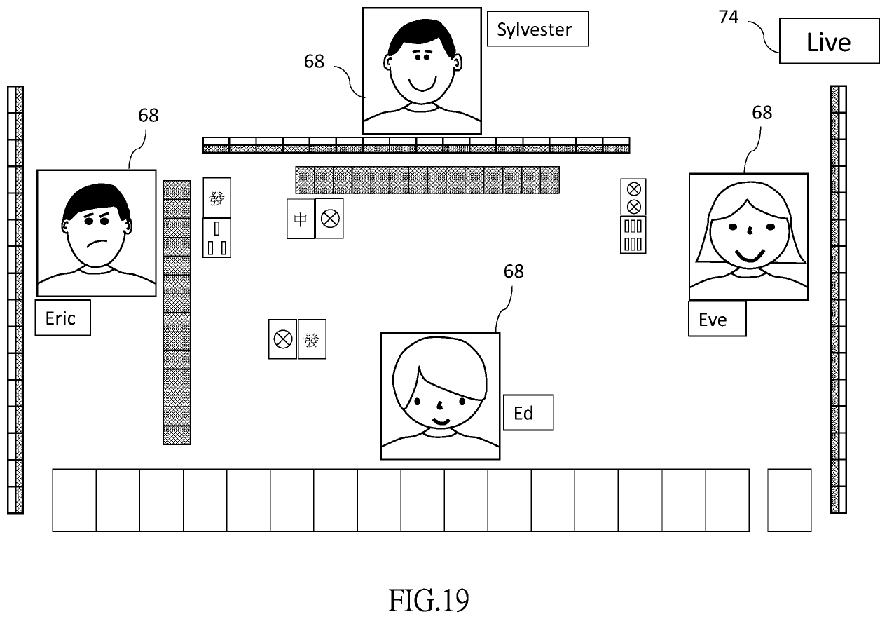

As illustrated in FIG. 19, the first video file is presented gameplay from a perspective of one of the first users. Each of the video regions 68 shows the live video of one of the first users, and the audio of each of the first users is added into at least one sound track of the first video file. In another embodiment, the audio of each of the first users could be added into different sound tracks of the first video file, so that each of the audios could be optionally played when watching the first video file. The first video file shows images of the concealed hand tiles held by each of the first users, but images of the contents of the concealed hand tiles are not shown. During the game process, the first video file shows images of the public tiles and the contents of the public tiles, wherein the public tiles could be the public tiles held by each of the first users, such as tiles of the meld made by chi or pong. The public tiles could also be tiles that are discarded. The server 10 could add an image 74 of “Live” to the first video file to demonstrate the first video file is a live stream. The first video file could be a streaming video that could be real-time delivered to and downloaded by the second computer 12b.

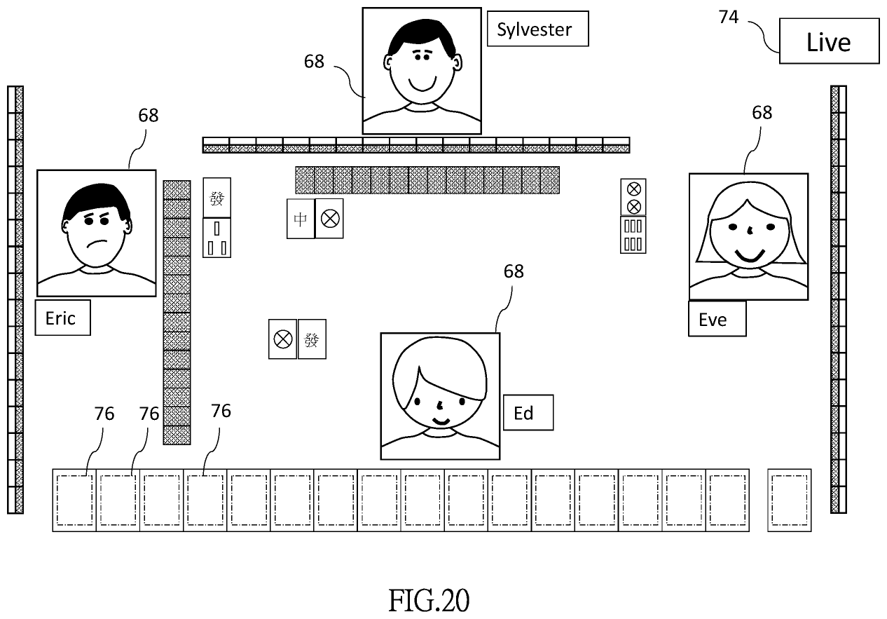

For example, as illustrated in FIG. 20, during the process of generating the first video file, the server 10 adds a mask layer to a region of the concealed hand tiles of the first user whose perspective is used to present the first video to block the contents of the concealed hand tiles. The mask layer includes a plurality of masks 76, wherein the masks 76 are located on the images of the concealed hand tiles of the first user, thereby blocking the image of the contents of the concealed hand tiles.

In the current embodiment, the at least one first video file includes a plurality of first video files, and each of the plurality of first video files is presented from the perspective of one of the first users.

Step S21-3: the server 10 transmits at least one first video file to the second computer 12b. In the current embodiment, after the second computer 12b is connected to the server 10, the second user could enter a watching mode in the game program of the second computer 12b. In the watching mode, after the second computer 12b is connected to the server 10, the second user could choose one of the first users to watch the live gameplay from the perspective of the chosen one of the first users. For example, when the first user chosen by the second user is “Ed”, the second computer 12b sends a download request to the server 10, and the server 10 transmits the first video file recorded from a perspective of “Ed” to the second computer 12b.

In an embodiment, another method for joining a game that is similar to the above mentioned is provided. The server 10 could set a positioning information for a game. The second user operates the second computer 12b to send a position searching command to the server 10, wherein the position searching command includes a searching region. The server 10 receives the position searching command sent from the second computer 12b. In the step S21-3, the server 10 determines the positioning information of games that are located within the searching region and sends a list of the games within the searching region to the second computer 12b. After the second user selects one of the games to watch, the second computer 12b sends a confirmation information to the server 10. After the server 10 receives the confirmation information, the server transmits the first video file of the game that is selected by the second user to the second computer 12b.

In an embodiment, another method for joining a game that is similar to the above mentioned, the server 10 provides an electronic map to the second computer, wherein the games are marked on the electronic map according to the positioning information of each of the games. After the user of the second computer 12b selects a game through the electronic map, a confirmation information is sent to the server 10 by the second computer 12b. In the step S21-3, after the server 10 receives the confirmation information, the first video file of the selected game is sent to the second computer 12b.

Step S21-4: the second computer 12b displays the first video file via the monitor 48, and the first video file shown on the monitor 48 does not display the contents of the concealed hand tiles.

In the current embodiment, the second computer 12b could obtain the first video file presented from the perspective of the first user “Ed” from the server 10 in real-time and display the selected first video file through the monitor 48. The second user could watch the gameplay through the perspective of “Ed” through the monitor 48, as shown in FIG. 19 and FIG. 20.

When the gameplay is live streamed, the contents of the concealed hand tiles held by the first user are not shown on a screen displayed by the monitor 48 which is connected to the second computer 12b. Therefore, live-streaming the game does not affect a result of game, thereby increasing the fairness of playing the game.

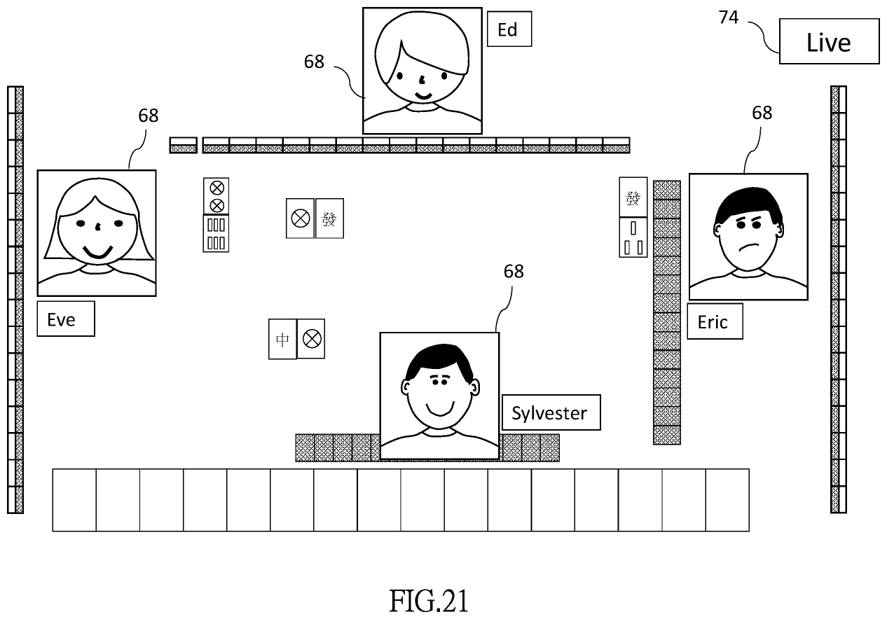

When the second user would like to watch the live gameplay from a perspective of another one of the first users, the second user could click a video region 68 of the another one of the first users or a region nearby the video region 68. At this time, the second computer 12b transmits a selecting command to the server 10, wherein the selecting command includes the first user who is selected. In the step S21-3, the server 10 selects one of the first video files according to the selecting command sent from the second computer 12b and transmits the selected first video file to the second computer 12b. As illustrated in FIG. 21, for example when the second user selects “Sylvester” of the first users, the second computer 12b obtains the first video file filed from a perspective of the first user of “Sylvester” in real-time and displays it through the monitor 48. Similarly, a screen of gameplay displayed through the monitor 48 does not show contents of concealed hand tiles of the first user of “Sylvester”.

The first video file could be provided for not only the second user, but also the first user to watch. More specifically, after the step S21-2, when one of first users wants to watch the gameplay from a perspective of another one of the first uses, the first user could click the another one of the first users on the monitor 48. At this time, the first computers 12a sends a selecting command to the server 10, wherein the selecting command includes the first user who is selected. The server 10 could select a first video file according to the selecting command and transmits the first video file to the first computer 12a that sends the selecting command. The first computers 12a displays the first video file in real-time through the monitor 48, wherein a screen of the first video file displayed through the monitor 48 does not show contents of concealed hand tiles of the first user who is selected.

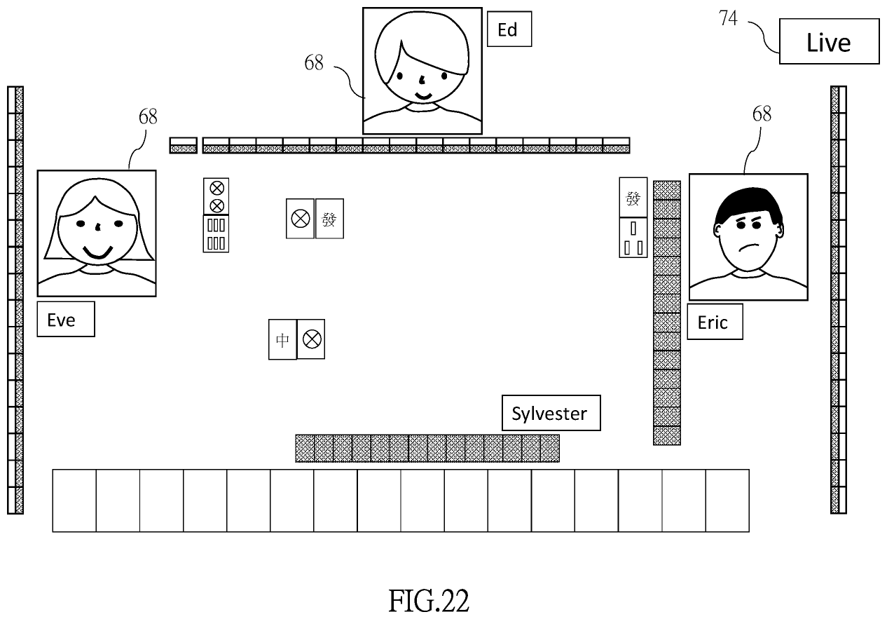

Additionally, the second user could click any one of the video regions 68 of the first users or a region nearby on the monitor 48. The second computer 12b shows a hint message through the monitor 48 to inquiry the second user whether or not to hide the video region 68 of the first user who is selected. If the second user decides to hide the video region 68 of the selected first user, the monitor 48 of the second computer 12b will hide the video region 68 of the selected first user and remain a name of the selected first user, as shown in FIG. 22. Click a video region 68 of any one of the first users or a region nearby, the video of the first user who is clicked could be displayed in full screen, wherein the click could be double click.

For example, each of the first video files could include a plurality of layers, wherein the layers could include a live video of the video region 68 of each of the four first users. When the second user chooses to hide the video region 68 of specific one or more of the first users, the second computer 12b hides the layer or layers that correspond to the video region 68 of the first user who is chosen by the second user. Similarly, when each of the first users watches the first video file through the monitor 48, images of the video regions 68 could be alternatively hidden.

Additionally, the first user or the second user could control the first computers 12a or the second computer 12b to mute the specific sound tracks of the first video file.

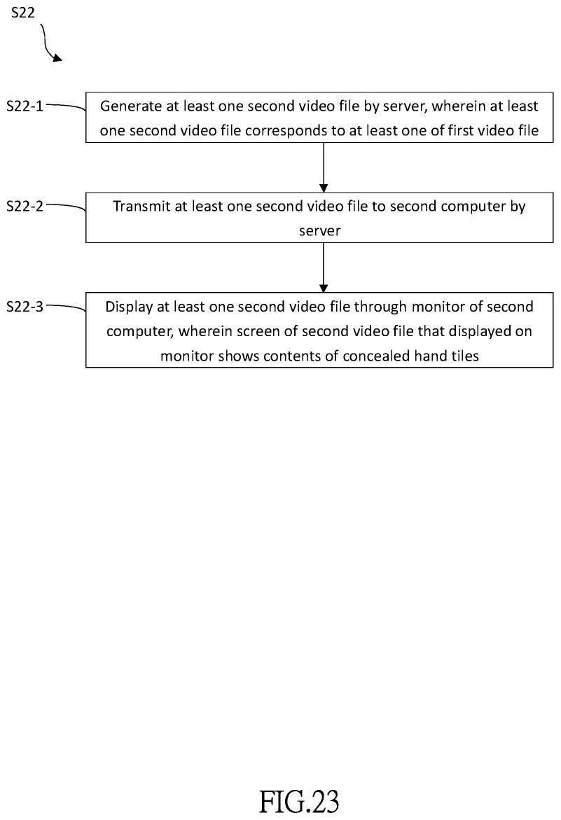

As illustrated in FIG. 23, the method for broadcasting gameplay of the current embodiment could further include the following steps for broadcasting the gameplay after the game is ended.

Step S22: After the game is ended, the following steps are conducted:

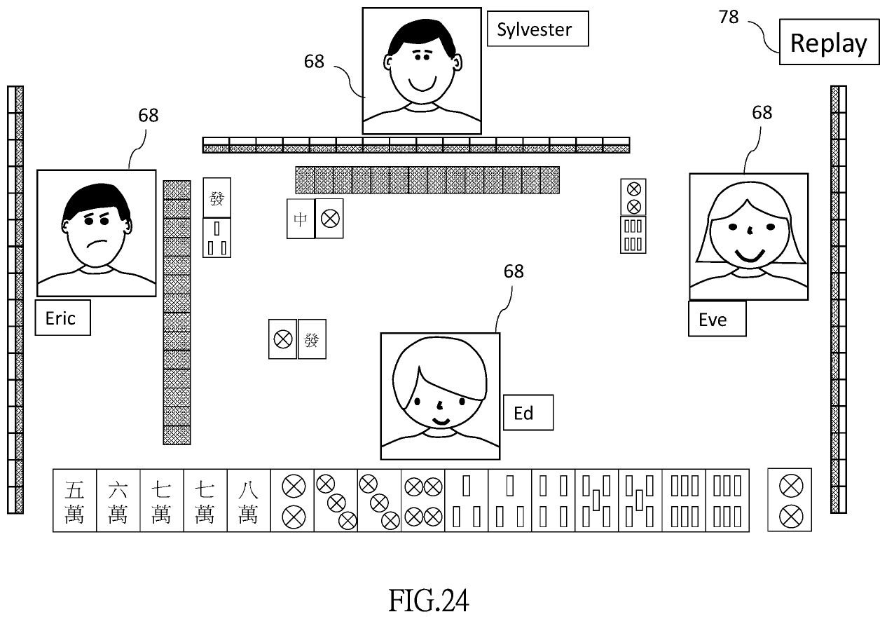

Step S22-1: the server 10 generates at least one second video file, wherein the at least one second video file corresponds to the at least one of first video file. In the current embodiment, the server 10 generates the second video file according to the first video file, as illustrated in FIG. 24. The server 10 makes the second video file include images of the contents of the concealed hand tiles held by each of the first users, such as cancel the mask layer. Besides, the server 10 could add an image 78 of “Replay” to the second video file, thereby demonstrating the video is rerun.

Step S22-2: the server 10 transmits at least one second video file to the second computer 12b. In the current embodiment, the second user could choose to replay the at least one second video file of a game in the watching mode of the game program running on the second computer 12b. The second user could use the second computer 12b to transmit a download request to the server 10 for requesting to download a second video file of one of the first user of the selected game.

After the second computer 12b is connected to the server 10, the second user could choose to watch the gameplay from one of the first users. For example, when the first user who is chosen is “Ed”, the server 10 transmits the second video file that recorded from the perspective of the first user of “Ed” to the second computer 12b.

Step S22-3: the second computer 12b displays the at least one second video file through the monitor 48, wherein a screen of the second video file that displayed on the monitor 48 includes the contents of the concealed hand tiles. In the current embodiment, the second computer 12b displays the second video file through the monitor 48. The second user could watch the gameplay from the perspective of the first user via the monitor 48, as shown in FIG. 24.

A way for displaying the second video file through the monitor 48 is the same as that of the first video file. For example, the second video file has a plurality of video regions 68, and the second user could select to hide one or more video regions 68 of the first users. By clicking the video region 68 of one of the first users or a region nearby, the video of the first user who is selected could be played in full screen, such as by double clicking.

In the step S22-2, when the second user would like to watch the gameplay from a perspective of another one of the first users, the second user could click the video region 68 of the another one of the first users or a region nearby. Then, the second computer 12b transmits a selecting command to the server 10, wherein the selecting command includes the first user who is selected. The server 10 selects one of the second video files that is recorded from a perspective of the another one of the first users to the second computer 12b, thereby switching the perspective of watching the gameplay.

Similarly, after a game is ended, the first user in the game could operate the game program for the first computers 12a to enter the watching mode, thereby watching the second video file through the monitor 48 of the first user.

In an embodiment, in the step S22-1, the at least one second video file generated by the server 10 includes the contents of all of the first users. In the step S22-3, when a screen of the second video file is displayed, the contents of the concealed hand tiles of the users are displayed through the monitor 48.

In an embodiment, in said step S21-3, when the server 10 generates the first video files during the game process, by processing the log data of the content of the concealed hand tiles and the holding time of each of the concealed hand tiles that are received by the server 10, the images of the concealed hand tiles could be adjusted by the server 10 according to the log data, and the contents of the concealed hand tiles are not shown on the images of concealed hand tiles in the first video files. For example, the adjustment to the images of the concealed hand tiles could be changing a number of the images of the concealed hand tiles. In the step S21-4, when the second computer plays any one of the first video files, the monitor 48 does not show the contents of the concealed hand tiles. After the game is ended, in the step S22-1, when the server 10 generates the second video files, by processing the log data of the content of the concealed hand tiles and the holding time of each of the concealed hand tiles, the contents of the concealed hand tiles are shown on the images of the concealed hand tiles in the second video files. In each of the second video files, the contents of the concealed hand tiles of the first users could be alternatively added. In another embodiment, the second video files could merely display the contents of the concealed hand tiles of the first user whose perspective is used to present the second video file.

In an embodiment, after the game is ended, the server 10 could analyze a legal hand of the winner, who is one of the first users, wherein the legal hand could be grand 3 chiefs, grand 4 happiness, heavenly hand, earthly hand, and so on. In the step S22-1, after the server 10 generates the second video files, the server 10 labels at least one of tags of types of the legal hand, wherein the tags of types of the legal hand include 3 chiefs, grand 4 happiness, heavenly hand, earthly hand, and so on. In different gambling games, the tags of types of the legal hand could be different. The second user could operate the second computer 12b to transmit a command of selecting types of legal hand to the server 10. The command of selecting types of legal hand includes at least one of the tags of types of the legal hand. After the server 10 receives the command of selecting types of legal hand sent from the second computer, the server 10 compares the tags of types of the legal hand in the command of selecting types of legal hand to the tags of types of the legal hand of the second video file. When the server 10 determines the tags of types of the legal hand of the second video file are complied with that of the command of selecting types of legal hand, the server 10 transmits the second video file to the second computer 12b. Thus, the second user could watch the gameplay that the winner is won by a certain type of legal hand through the monitor 48.

For increasing the entertainment of the game, the server 10 could set a betting time and wait for a betting command sent from the second computer 12b during or before the game is live streamed. When the server 10 determines any one of the first users of the first computers achieves a condition that could terminate the betting time, the betting time is terminated. For example, the condition that could terminate the betting time could be that a number of the public tiles held by the first user attains a predetermined number, or the concealed hand tiles (including public tiles and private tiles) held by the first user is a ready hand.

Within the betting time, the second user transmits the betting command to the server 10 to bet one of the first users will win the game. For example, the betting command includes a betting point and the first computer 12a of one of the first users. After the second computer 12b transmits the betting command, the server 10 will take a certain amount of points from the game points of the game account of the second user to be the betting point. The server 10 records the name and the game account of the first user who is indicated.

After the game is ended, the following steps are conducted:

When the server 10 determines the indicated first user of the betting command wins the game, a part or all of bonus points could be deposited into the game account of the second user. Namely, when the second user bet a first user will win, and the first user wins the game, the server 10 not only returns the betting point, but also deposits the bonus points to the game account of the second user

In another embodiment, the server 10 could deposit a part of the bonus points to the game account of the second user and deposit a part of the bonus points to the game account of the first user who wins the game. The server 10 could contribute a part of bonus points according to a predetermined dividend ratio. For example, the dividend ratio could be 85:15 which means taking 85% of bonus points to the second user and 15% of bonus points to the first user. In another embodiment, the betting command could include the dividend ratio. In other words, the second user could set the dividend ratio of the bonus points in the server 10.

Thus, since a part of the bonus points that won by the second user will be shared with the first user as long as the first user wins the game, a motivation of the first user to win could be enhanced, thereby increasing excitation of playing the game.

It must be pointed out that the embodiment described above is only a preferred embodiment of the present invention. All equivalent structures and methods which employ the concepts disclosed in this specification and the appended claims should fall within the scope of the present invention.

What is claimed is:

1. A method of broadcasting gameplay applied to a game system, wherein the game system comprises a plurality of computers and a server; the plurality of computers is connected to the server via the internet and comprises a plurality of first computers and a second computer; each of the plurality of computers is provided for one of a plurality of users to use; each of the first computers is connected to a first monitor and a camera device, wherein the first monitor is adapted to display a game screen; when the user is playing a game, each of the plurality of first computers obtained a video and an audio of the user through the camera device; the second computer is connected to a second monitor; the method of broadcasting gameplay comprises the following steps:
A. during a game process:
A1. receiving the video and the audio that is obtained by each of the first computers by the server;
A2. generating at least one first video file based on the video and the audio obtained by at least one of the first computers by the server, wherein the at least one first video file comprises the videos and the audios obtained by the first computers, and a plurality of concealed hand tiles of at least one of the user;
A3. transmitting the at least one first video file to the second computer by the server;
A4. displaying the at least one first video file through the second monitor by the second computer, wherein a screen of the at least one first video file displayed through the second monitor does not show contents of the plurality of concealed hand tiles.

2. The method of broadcasting gameplay as claimed in claim 1, wherein in the step A2, when the server generates the at least one first video file, the server adds a mask layer to a region of the concealed hand tiles of the at least one of the users to block the contents of the concealed hand tiles.

3. The method of broadcasting gameplay as claimed in claim 1, further comprising:
B. after the game is ended:
B1. generating at least one second video file by the server, wherein the at least one second video file corresponds to the at least one first video file;
B2. transmitting the at least one second video file to the second computer by the server;
B3. displaying the at least one second video file through the second monitor by the second computer, wherein a screen of the at least one second video file displayed through the second monitor shows the contents of the concealed hand tiles.

4. The method of broadcasting gameplay as claimed in claim 3, wherein in the step A2, when the server generates the at least one first video file, the server adds a mask layer to a region of the concealed hand tiles of the at least one of the users;
wherein in the step B1, when the server generates the at least one second video file, the mask layer on the region of the concealed hand tiles of the at least one of the users the is canceled.

5. The method of broadcasting gameplay as claimed in claim 3, wherein in the step B1, the second video file generated by the server comprises images of the contents of the concealed hand tiles held by each of the first users; in the step B3, the screen of the at least one second video file that is displayed through the second monitor of the second computer comprises the contents of the concealed hand tiles of the users.

6. The method of broadcasting gameplay as claimed in claim 3, wherein in the step B1, the second video file generated by the server comprises a plurality of video regions, and each of the video regions shows the video obtained by one of the first computers; in the step B3, when the second computer displays the second video file, a user of the second computer is able to selectively hide one or more video regions.

7. The method of broadcasting gameplay as claimed in claim 1, wherein in the step A1, the server further receives a plurality of log data obtained by the first computers; the log data comprises the contents of the concealed hand tiles and a holding time of each of the concealed hand tiles; wherein in the step A2, when the server generates the at least one first video file, the servers adjusts images of the concealed hand tiles according to the log data, and the contents of the concealed hand tiles does not show on the images of the concealed hand tiles.

8. The method of broadcasting gameplay as claimed in claim 7, comprising the following steps:
B. after the game is ended:
B1. generating the at least one second video file that corresponds to the at least one first video files by the server, wherein when the server generates the at least one second video, the contents of the concealed hand tiles are added to the images of the concealed hand tiles according to the log data;
B2. transmitting the at least one second video file to the second computer by the server;
B3. displaying the at least one second video file through the second monitor by the second computer, wherein a screen of the at least one second video file displayed through the second monitor shows the contents of the concealed hand tiles.

9. The method of broadcasting gameplay as claimed in claim 8, wherein in the step A1, the log data comprises the contents of the concealed hand tiles and a holding time of each of the concealed hand tiles; wherein in the step A2, the server adds the images of the concealed hand tiles of the users according to the log data of the first computers;
wherein in the step B1, the server adds the contents of the concealed hand tiles to the images of the concealed hand tiles of the users according to the at least one second video file, according to the log data of the first computers; in the step B3, the second monitor displays the screen of the at least one second video file, wherein the screen of the at least one second video file shows the contents of the concealed hand tiles of the users.

10. The method of broadcasting gameplay as claimed in claim 1, wherein in the step A2, the at least one first video file generated by the server comprises a plurality of first video files, and each of the plurality of first video files corresponds to one of the users of the first computers; each of the first video files has the video and the audio obtained by the first computers, and a plurality of concealed hand tiles of the users of the first computers; in the step A3, the server receives a selecting command transmitted from the second computer to select one of the first video files and sends the selected first video files to the second computer; in the step A4, the second computer displays the selected first video file through the second monitor.

11. The method of broadcasting gameplay as claimed in claim 10, comprising the following steps:
B. after the game is ended
B1. generating a plurality of second video files by the server, wherein the second video files correspond to the first video files
B2. selecting one of the second video files in accordance with another selecting command and transmitting to the second computer by the server;
B3. displaying the selected one of the second video files through the second monitor by the second computer, wherein a screen of the at least one second video file displayed through the second monitor shows the contents of the concealed hand tiles

12. The method of broadcasting gameplay as claimed in claim 1, wherein in the step A2, the at least one first video file generated by the server comprises a plurality of first video files that respectively correspond to one of the users of the first computers; each of the first video files has the video and the audio obtained by the first computers and a plurality of concealed hand tiles of at least one of the user; after the step A2, the method comprises the following steps:
selecting one of the first video files according to a selecting command sent from the first computers to transmit to the first computer that sends the selecting command by the server;
displaying the selected first video file through the first monitor of the first computers that sends the selecting command, wherein a screen of the first video file displayed through the first monitor does not show the contents of the concealed hand tiles.

13. The method of broadcasting gameplay as claimed in claim 12, wherein in the step A2, the at least one first video file has a plurality of the video regions, and each of the video regions shows the video obtained by one of the first computers; wherein after the step A2, when the first computer that sends the selecting command displays the first video files, one or more the video regions could be alternatively hidden.

14. The method of broadcasting gameplay as claimed in claim 1, wherein in the step A2, the at least one first video file has a plurality of video regions, and each of the video regions shows the video obtained by one of the first computers; in the step A4, when second computer display the first video file through the second monitor, a user of the second computer is able to selectively hide one or more video regions

15. The method of broadcasting gameplay as claimed in claim 3, wherein in the step B1, the server labels one or more tags of types of the legal hand to the at least one second video file, wherein the tags of types of the legal hand comprise
wherein before the step B2, the server receives a command of selecting types of legal hand transmitted from the second computer, and the command of selecting types of legal hand comprises at least one of the tags of types of the legal hand; in the step B2, the server compares the tags of types of the legal hand in the command of selecting types of legal hand to the tags of types of the legal hand of the second video file; when the server determines the tags of types of the legal hand of the second video file are complied with that of the command of selecting types of legal hand, the server transmits the at least one second video file to the second computer.

16. The method of broadcasting gameplay as claimed in claim 1, comprising setting a positioning information for a game by server, wherein the server receives a position searching command sent from the second computer; and the position searching command comprises a searching region; wherein in the step A3, when the server determines the positioning information of games that located within the searching region, the server transmits at least one first video file to the second computer.

17. The method of broadcasting gameplay as claimed in claim 1, comprising setting a positioning information for a game by server; the server provides an electronic map to the second computer, wherein games are marked on the electronic map according to the positioning information of the games;
wherein in the step A3, after the server receives a confirmation message from the second computer, the sever transmits the at least one first video file to the second computer.

18. The method of broadcasting gameplay as claimed in claim 1, comprising setting a betting time by the server, wherein during the betting time, the server receives a betting command from the second computer, wherein the betting command comprises a betting point and indicated one of the users of the first computers.
wherein after the game is ended, the method comprises the following steps:
depositing a part of bonus points to an account of the user of the second computer when the server determines the indicated first user of the betting command of the second computer wins the game.

19. The method of broadcasting gameplay as claimed in claim 18, wherein the server determines the indicated first user of the betting command wins the game, the part of bonus points to an account of the user of the second computer, and another part of the bonus points is deposited into an account of the indicated first user of the betting command of the second computer.

20. The method of broadcasting gameplay as claimed in claim 19, wherein the betting command comprising a dividend ratio; the server determines the indicated first user of the betting command of the second computer wins the game, the server deposits the bonus points in accordance with the dividend ratio to the account of the user of the second computer and the indicated first user of the betting command, respectively.

21. The method of broadcasting gameplay as claimed in claim 18, wherein when the server determines any one of the users of the first computers achieved a condition for terminating the betting time, the betting time is terminated.

22. A method for joining a game applied to a game system, wherein the game system comprises a plurality of computers and a server, wherein the plurality of computers are connected to the server via the internet and comprises a starting computer and at least one participating computer; the starting computer is provided for setting up a new game, wherein the method for joining the game comprises the following steps:
A. receiving a starting command from the starting computer by the server to open a new game, wherein the starting command comprises at least one bidding condition of the new game;
B. waiting to receive a bidding command from at least one participating computer by the server, wherein the bidding command comprises a bidding price; after the server receives the bidding command of the at least one participating computer, the following steps are conducted:
determining whether the bidding price is complied with the bidding condition or not by the server; if yes, the participating computer is joined into the new game.

23. The method for joining the game as claimed in claim 22, wherein in the step A, the server receives a positioning information of the starting computer and connects the positioning information with the new game;
before the step B, the server receives a position searching command of the at least one participating computer, wherein the position searching command comprises a searching region; when the server determines the positioning information is located within the searching region, the at least one bidding condition of a game is sent to the at least one of the participating computers.

24. The method for joining the game as claimed in claim 23, wherein the server further saves a user information of the starting computer; before the step B, the user information of the starting computer is sent to the at least one participating computer.

25. The method for joining the game as claimed in claim 22, wherein in the step A, the server receives a positioning information of the starting computer and connects the positioning information with the new game;
before the step B, the server provides an electronic map to the at least one participating computer, wherein games are marked on the electronic map according to the positioning information of the new games; after the server receives a confirmation message of the at least one participating computer, the at least one bidding condition of a selected game in the confirmation message is sent to the at least one of the participating computers.

26. The method for joining the game as claimed in claim 25, wherein the server further saves a user information of the starting computer; before the step B, the user information of the starting computer is sent to the at least one participating computer.

27. The method for joining the game as claimed in claim 22, wherein before the step B, the server sets a bid participation time; in the step B, the server waits for receiving the bidding command of the at least one participating computer within the bid participation time.

28. The method for joining the game as claimed in claim 22, wherein in the step A, the starting command comprises a plurality of participants who are indicated to join the new game and at least one bidding condition for at least one of the indicated participants.

29. The method for joining the game as claimed in claim 29, wherein in the step A, the at least one bidding condition comprises a plurality of bidding conditions, and the starting command indicates each of the plurality of bidding conditions for one of the plurality of the participants.

30. The method for joining the game as claimed in claim 22, wherein the starting computer is connected to a camera device, and the starting computer obtains a video and an audio by the camera device and uploads the video and the audio; the server transmits the video and the audio obtained by the starting computer to the at least one participating computer.
